(19) United States
(12) Patent Application Publication
(10) Pub. No.: US 2016/0104466 A1
(43) Pub. Date: Apr. 14, 2016

(54) STRING FOR A MUSICAL INSTRUMENT

(71) Applicant: THOMASTIK-INFELD GESELLSCHAFT M.B.H., Wien (AT)

(72) Inventor: Franz Klanner, Wien (AT)

(73) Assignee: THOMASTIK-INFELD GESELLSCHAFT M.B.H., Wien (AT)

(21) Appl. No.: 14/871,206

(22) Filed: Sep. 30, 2015

(30) Foreign Application Priority Data
Oct. 8, 2014 (AT) A 756/2014

(51) Int. Cl. G10D 3/10

(52) U.S. Cl. CPC G10D 3/10

(57) ABSTRACT

A string for a bowed musical instrument having a supporting string core and at least one outer winding layer is disclosed. The outer winding layer comprises first and second winding bands having identical thicknesses, and a substantially rectangular cross-section. The outer winding layer being a composite winding layer wherein the materials used in the first and second winding elements having respective different thermal conductivities differs from each other by at least 170 W/mK.

### CROSS-REFERENCES TO RELATED APPLICATIONS

This application claims the priority of Austrian Patent Application, Serial No.: A 75612014, filed on Oct. 8, 2014, pursuant to 35 U.S.C. 119(a)-(d), the disclosure of which is incorporated herein by reference in its entirety as if fully set forth herein.

### BACKGROUND OF THE INVENTION

The strings of musical instruments have a string core that is stressed when the string of the musical instrument is tensioned. The strings of bowed musical instruments having lower tuning usually have wrappings or winding layers to increase the area density of the string. The fundamental frequency at which a musical instrument's string vibrates depends on the vibrating length or the thickness of the relevant string of the musical instrument, the force with which the relevant string of the musical instrument is tensioned and the area density of the string of the musical instrument. In this context, the respective structure of the string of a musical instrument has a major influence on the sound thereof, in particular its harmonic distribution as well its playability, in particular its speaking and reacting to a direction change by the bow.

During bowing, the bow is moved over the string so that its hairs (horse hair) excite the string to vibrate with the aid of the rosin applied to the bow. In this case, the bow moves uniformly in one direction during many periods of the string vibration and a so-called tilting vibration is formed as a result of the change of sticking and slipping (stick-slip) between bow and string.

Initially, the string of the musical instrument sticks to the bow hairs by means of the rosin. Due to this sticking, the string is moved away from its rest position, i.e. kinetic energy is supplied until the string tension becomes so high that the string of the musical instrument detaches from the bow hairs and begins to spring back toward its rest position. Because of the heat produced by friction during the accompanying relative movement, the rosin fuses. The string of the musical instrument springs beyond the rest position, where the relative speed between the string of the musical instrument and the bow moved further in its original direction decreases continuously and ultimately to zero. This results in a rapid cooling of the rosin with the result that this again becomes effective as an adhesive agent and sticks the string of the musical instrument to the bow hairs.

In addition to the desired sound of the string of the musical instrument, the bowing process itself generates an inherent noise which is designated as bow noise. The bow noise is typical for a certain type of string of a musical instrument and can be influenced only to a small extent by the playing technique of the musician, possibly by changing the bowing point or by changing the bow pressure, however each of the relevant measures also has a direct influence on the sound of the entire instrument. That is, the bowing point can have a direct influence on the distribution of the harmonic tones, and therefore on tone colour, whereas the bow pressure has an influence on the brilliance of the string.

### SUMMARY OF THE INVENTION

A string for a musical instrument is advantageously provided in accordance with the invention. In particular bow noise is influenced, or is adjusted during the construction of the string so that the musical instrument has soft, unobtrusive bow noise.

In accordance with the invention, a string for bowed musical instruments has a supporting string core and at least one outer winding layer, said at least one outer winding layer comprising at least one first winding element. Advantageously, the first winding element is constructed of a first material having a first thermal conductivity; and at least one second winding element. The second winding element is constructed of a second material having a second thermal conductivity, said first thermal conductivity differing from said second thermal conductivity by at least 170 W/m.K, said at least one first winding element and said at least one second winding element being wound around the string core in the form of a multi-strand helix. The first and second winding elements are configured as bands having substantially identical thicknesses and substantially rectangular cross-sections. The substantially rectangular cross-sections have a pre-defined edge formation.

In accordance with the invention, a musical instrument can be provided which has very unobtrusive bow noise. Studies have shown that during a transition from static friction to sliding friction, not all the bow hairs simultaneously “tear away” from the string of the musical instrument. Depending on the sloping position of the bow with respect to the string of the musical instrument, usually about between 10 and 100 bow hairs stick to the string of the musical instrument during the sticking phase. In the transition from the sticking phase to the slipping phase of the string with respect to the bow, this results in a detachment of the bow hairs individually or in groups, where in each case not all the bow hairs can be separated from the string of the musical instrument at the same moment. This transition is mainly responsible for the formation and manifestation of the bow noise. This also applies, albeit to a lesser degree, to the transition from the slipping phase to the sticking. Other studies have shown that the thermal conductivity of the winding layer has a major influence on these transition phases. The thermal conductivity of the winding layer influences the speed at which the rosin melts or solidifies.

The bow hair in contact with the string of the musical instrument always contacts a plurality of turns or wrappings of the outer winding layer as a result of the conventional dimensions of the parts involved. During the bowing process a first part of the bow hairs is in contact with turns of the first winding element and a second part of the bow hairs is in contact with turns of the second winding element on a given string of the musical instrument. As a result of the significantly different thermal conductivity of the two winding elements, at least 170 W/m.K, this results in different behaviour in the adjacent turns having different thermal conductivities during the transition from the sticking phase to the slipping phase, and conversely.

Those very different winding elements would be expected to merely produce very different bow noises. However, it has been discovered that a combination of such winding elements produces a very different bow noise result, a bow noise that is perceived as pleasant, gentle and unobtrusive result in a bowed string instrument. Furthermore, the bow noise produced can be specifically taken into account or adjusted when the string is constructed.

In a further advantageous embodiment of a string of a musical instrument, density can be effectively adjusted over wide ranges during the development of string of a musical instrument, with the result that the string of the musical instrument can be well adapted to its desired tuning pitch, by combing the first winding element with the second winding element inside a winding layer having high mechanical strength, the area density and the diameter of the string of a musical instrument can advantageously be adjusted over wide ranges. The diameter of a string of a musical instrument has a direct influence on the response of the relevant string of a musical instrument and on the occurrence of unharmonic overtone distortions as a result of torsional distortions.

In a further advantageous embodiment, the string has a third winding element in the composite winding layer constructed of a third material having a third thermal conductivity differing from the first thermal conductivity and from the second thermal conductivity by at least 170 W/mK, providing additional adjustability.

In a particular advantageous embodiment, the string has a winding layer disposed between the outer winding layer and the string core extending the pitch range of strings in accordance with the present invention.

In a further advantageous adjustable embodiment, the string has at least one further winding layer that is a composite winding layer.

In another advantageous adjustable embodiment of the string, the first and second bands have different widths.

In another advantageous embodiment the third winding element is a third band and has a thickness that is substantially identical to the thickness of the first and second band.

In accordance with another embodiment of the invention, the string has a composite winding layer that is selected from a group of combinations consisting of two first winding elements and one second winding element; one first winding element and two second winding elements; three first winding elements; one second winding element, one first winding element and three second winding elements; two first winding elements and two second winding elements; or one first winding element and one second winding element and one third winding element.

In an advantageous embodiment at least one of the windings is made of a material selected from a group consisting of: steel, silver, silver alloy, aluminium, aluminium alloy, titanium, titanium alloy, nickel, and nickel alloy.

In a particular embodiment a polymeric damping layer is disposed on at least one region of the composite winding layer facing the string core.

Advantageously the string has at least one coating is disposed on at least one of the winding elements. Preferably at least one coating is an oxide layer, a nitride layer, or a sulfide layer.

### BRIEF DESCRIPTION OF THE DRAWINGS

Other features and advantages of the present invention will be more readily apparent upon reading the following description of currently preferred exemplified embodiments of the invention with reference to the accompanying drawing.

The invention will be better understood when the detailed description of preferred embodiments is considered in conjunction with the drawings provided, wherein:

FIG. 1 shows a first embodiment of a given string of a musical instrument; and

FIG. 2 shows a second embodiment of a given string of a musical instrument.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

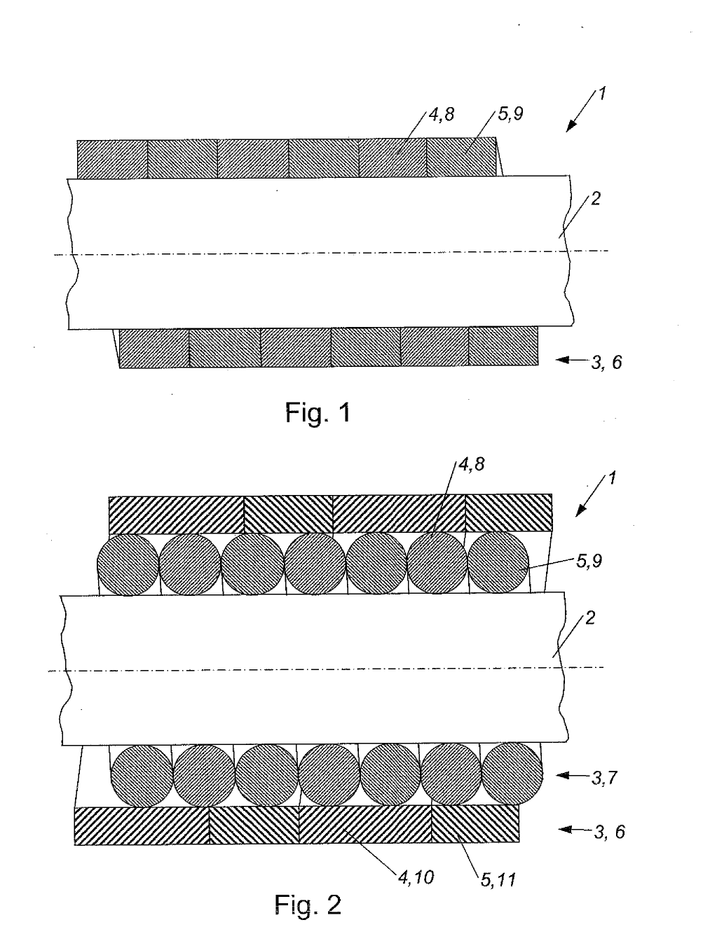

FIGS. 1 and 2 show embodiments of a string of a musical instrument 1 for bowed instruments, having a supporting string core 2 and at least one outer winding layer 6 which comprises at least one first winding element 4 and at least one second winding element 5, wherein the at least one first winding element 4 and the at least one second winding element 5 are wound around the string core 2 in the form of a multi-start helical line, wherein the outer winding layer 6 is configured as a composite winding layer 3, wherein the first winding element 4 consists of a first material having a first thermal conductivity, wherein the second winding element 5 consists of a second material having a second thermal conductivity and wherein the first thermal conductivity differs from the second thermal conductivity by at least 170 W/mK.

As a result, a string of a musical instrument 1 can be provided in which the bow noise can be specifically influenced or adjusted. In particular, a string of a musical instrument 1 can be provided which has a very unobtrusive bow noise. Studies have shown that on transition from static friction to sliding friction, not all the bow hairs simultaneously “tear away” from the string of the musical instrument 1. Depending on the sloping position of the bow with respect to the string of the musical instrument 1, usually about between 10 and 100 bow hairs stick to the string of the musical instrument 1 during the sticking phase. In the transition from the sticking phase to the slipping phase of the string of the musical instrument 1 with respect to the bow, this results in a detachment of the bow hairs individually or in groups, where in each case not all the bow hairs are separated from the string of the musical instrument 1 at the same moment. It could be established that this transition phase is mainly responsible for the formation and also the manifestation of the bow noise. The same applies, albeit to a lesser degree, for the transition phase from the slipping phase to the sticking phase. Studies have shown that the thermal conductivity of the outermost or outer winding layer 6 has a major influence on said transition phases. This influences the speed at which the rosin melts or solidifies.

The bow hair in contact with the string of the musical instrument 1 always contacts a plurality of turns or wrappings of the outer winding layer 6 as a result of the usual or possible dimensions of the parts involved. In a specific string of a musical instrument 1, during the bowing process therefore, a first part of the bow hairs is in contact with turns of the first winding element 4 and a second part of the bow hairs is in contact with turns of the second winding element 5. As a result of the significantly different thermal conductivity of at least 170 W/mK of the two winding elements 4, 5, this therefore results in a different behaviour in the adjacently disposed different turns during the transition from the sticking phase to the slipping phase or conversely.

Such different winding elements 4, 5 by themselves alone produce highly different bow noise, where it has been shown that a combination of such winding elements 4, 5 with highly different bow noise results in a string of a musical instrument 1 with a bow noise that is perceived as pleasant, gentle and unobtrusive.

As a result, the bow noise of a string of a musical instrument 1 can be specifically taken into account or adjusted during its construction. Furthermore, a string of a musical instrument 1 having a significantly less conspicuous or gentler bow noise can be produced as a result.

Furthermore, as a result of the specific design of a string of a musical instrument 1, the area density can be effectively adjusted over wide ranges during the development of string of a musical instrument 1, with the result that the string of the musical instrument 1 can be well adapted to its desired tuning pitch. As a result of the combination of the first winding element 4 with the second winding element 5 inside a winding layer 6, with given high mechanical strength, the area density and the diameter of the string of a musical instrument 1 can advantageously be adjusted over wide ranges. The diameter of a string of a musical instrument 1 has a direct influence on the response of the relevant string of a musical instrument 1 and on the occurrence of unharmonic overtone distortions as a result of torsional vibrations.

The various embodiments shown in the figures are depicted in simplified view. The proportions need not correspond to the envisaged real proportions. For better understanding, individual parts have been shown in greatly enlarged view. Furthermore, in the diagrams the individual parts of the strings of a musical instrument 1 shown are each shown resting directly against one another, whereas in this respect real strings of a musical instrument 1 according to the specific invention can have partial spacings between individual parts or at individual locations.

A major use of such strings 1 is by the instruments of the violin family: the violin or fiddle, the viola, the violoncello or cello and the double bass or contrabass or bass violin. Other preferred instruments for use of the strings of a musical instrument 1 according to the invention are viola da gamba and viola d'amore. Such strings 1 can be provided for all bowed string instruments.

Strings of a musical instrument 1 according to the invention are provided for producing tonal vibrations, a certain type of string 1 is provided for a wide variety of musical instruments, having respective tuning pitches and a so-called tuning weights. Tuning pitch specifies the fundamental tone at which a free part of the string of a musical instrument 1 between its end regions, vibrates. The length of the specific type of musical instrument on which the string of the musical instrument 1 is loaded, tensioned and naturally excited to vibrate, affects the required tuning weight of the string.

The string core 2 is configured to absorb the loading or tension to which the string 1 is exposed in the tensioned state on a musical instrument. The string core 2 is preferably configured as a single wire, a wire cable, a plastic fibre bundle or a natural gut. Each of these different types of a string core 2 are known per se for strings of a musical instrument 1 and each have certain advantages or preferred operational environments. The specific invention can be implemented with each of these types of string cores 2.

The string of a musical instrument 1 has at least one outer, outermost, or external winding layer 6 which includes a composite winding layer 3 having at least one first winding element 4 and at least one second winding element 5. Preferably, to increase adjustability, the composite winding layer 3 comprises a third winding element—not shown in FIGS. 1 and 2.

The at least one first winding element 4 and the at least one second winding element 5 and, optionally, a third winding element, are wound around the string core 2 in the form of a multi-strand helix. In the cases of merely one first and one second winding element 4, 5, the two winding elements 4, 5, are wound around the string core 2 in the form of a two-start helical line which can also be called a double helix. In the case of three winding elements in total wound around the string core 2 in the form of a three-strand helix, and in the case of four winding elements, these are wound around the string core 2 in the form of a four-strand helix.

The at least one first and the at least one second winding element 4, 5 are therefore wound in each case around the string core 2 in the form of a helix wherein the second winding element 5 is disposed adjacent to the first winding element 4 in the same winding layer. FIG. 1 shows a schematic view of a specific string of a musical instrument 1 where the two winding elements 4, 5 are shown as being different by using different shadings. As shown, the two winding elements 4, 5 alternate along the longitudinal extension of the string of a musical instrument 1 and jointly form the composite winding layer 3. “Two first winding elements 4” refers to two winding elements made of the same material.

The first winding element 4 and the second winding element 5 are wound onto the string core 2 during production of the string 1, so that the first winding element 4 and the second winding element 5 are wound closely adjacent to one another, so that substantially no intermediate spaces, or only very small intermediate spaces, occur between the individual adjacent windings. It can however also be provided that a predefined intermediate space is provided between the individual adjacent windings.

The outer winding layer 6 has a composite winding layer 3, with a first winding element 4, and a second winding element 5 that is different from the first winding element 4. The two winding elements 4, 5 in this case comprise different materials or substances. The thermal conductivity of the first material of the first winding element 4 here is different from the second material of the second winding element 5 by at least 170 W/m.K. The thermal conductivity can also be referred to as thermal transfer.

Within the possible material pairs some have, in practice, been shown to be particularly advantageous with regard to the sound quality achievable, the bow noise in particular, as a result of differences in thermal conductivity.

It is further provided according to a particularly preferred embodiment of a string of a musical instrument that the composite winding layer comprises a third winding element which, like the other two winding elements is wound in a helical line shape about the string core. The third winding element consists of a third material having a third thermal conductivity that preferably differs from the first thermal conductivity and also from the second thermal conductivity by at least 170 W/m.K.

For example, the first material can be silver having a thermal conductivity of about 429 W/m.K, the second material can be aluminium having a thermal conductivity of about 236 W/m.K and the third material can be titanium having a thermal conductivity of about 22 W/m.K. Here, the difference between the individual thermal conductivities is in each case greater than 170 W/m.K, and the respective thermal conductivities are in each case related to the materials themselves, if surface effects, possibly due to oxide layers, are disregarded.

Preferably the material used for one of the windings is steel, or silver or a silver alloy, or aluminium or an aluminium alloy, or titanium or titanium alloy, or nickel or a nickel alloy. In particular, it is anticipated that it may not possible to use tungsten or a tungsten-based alloy in these windings.

The preferred embodiments are described below with reference to the individual metals that are preferred. In particular, the steel preferably has a Cr content of at least 5% and/or an Ni content of at least 5%. Such steel has inherent rust-inhibiting properties even if such steel is not considered to be rust-free. It has been shown however that a steel with such a chrome and nickel content provides a string that remains largely free from sound-damaging corrosion, such that the corrosion which does occur is also not a factor that limits the lifetime of the relevant string of a musical instrument.

By using steel in one of the winding elements 4, 5, a high resistance can additionally be achieved, to bending loads, in particular. This can prevent any tearing of the winding elements 4, 5 on the bridge of a musical instrument. As a result, a long-lived string 1 can be provided for a musical instrument.

It is preferably provided that the steel is a stainless steel, therefore that the steel has a Cr content of at least 10.5%. According to particularly preferred embodiments, a steel having a Cr content of 17% to 20% and an Ni content of 8% to 12% is used. In particular, the following types of steel are particularly preferably used: X5CrNi18-10, X8CrN1S10-9, X2CrNi19-11, X2CrNi18-9, X10CrNi18-8, X12CrNi17-7, X5CrNiMo17-12-2, X2CrNiMo17-12-2. Furthermore steels from the material group 1.47XX are particularly preferred, steel having the material number 1.4767 in particular, which can also be designated as X8CrAl20-5. As a result, a string 1 that is, as far as possible, resistant to the effects of hand perspiration and air humidity, can be provided for a musical instrument

When configuring one of the materials as silver, the silver is preferably pure silver, which may have a degree of purity of 99.999% or 99.6% or be fine-grained silver. When one of the materials is a silver alloy, it is preferably a alloy selected from the group consisting of AgCu, AgCu 2, AgCu 6, AgPt 16, AgRh 16, AgCuNi, and Sterling silver.

When one of the materials is configured as aluminium, it is preferably provided that the aluminium is configured as pure aluminium. When one of the materials is configured as aluminium alloy, it is preferably provided that the aluminium alloy is configured as an aluminium kneading alloy, in particular as AlMg, AlMg 5, AlMgMn, AlCuMg, AlCuSiMn, AlZnMg, AlMgSiCu. In this case, it is provided in particular that the aluminium kneading alloy is configured as kneading alloy having the material number 5XXX, e.g. AlMg having an Mg fraction of 0.5% to 5.6%, in particular AlMg5; or AlMgMn alloys having an Mg fraction of 0.5% to 5.5% as well as an Mn fraction of 0.1% to 3% and a Cr fraction of 0.05% to 0.5%. Alternatively a heat-treatable kneading alloy may be used, Preferably a heat-treatable kneading alloy having the material numbers 6XXX or 7XXX, particularly as a AlCuMg, AlCuSiMn, AlZnMg, AlMgSiCu alloy. Furthermore the aluminium kneading alloy of the material number group 8XXX, particularly one comprising lithium, may advantageously be used

When one of the materials used is as titanium, preferably it is pure titanium of Grade 1 or Grade 2 or Grade 3 or Grade 4 of the ASTM standard. When one of the materials is a titanium alloy, it is preferably a titanium kneading alloy in accordance with TiAl 6 V 4, TiAl 6 V 6 Sn 2, TiAl 4 Mo 4 Sn 2.

When one of the materials is nickel, it is preferably pure nickel. When one of the materials is a nickel alloy, it is preferably provided that the nickel alloy is configured as nickel kneading alloy, in particular Ni99.2, Ni99.6, Ni99.8, NiMn2.

The preferred or particularly preferred materials listed above have proved advantageous in practice in regard to their processability making them suitable as material for a manufacturing a winding element in the string, and also with regard to the tonal and playing results of the string.

It can further be provided that at least one coating is disposed on the first winding element 4 and/or the second winding element 5 and/or the third winding element. In this case, it can in particular be provided that the surface of the first and/or the second and/or the third winding element 4, 5 is coated with at least one metal, in particular brass, tin, nickel and/or a plastic, or a polymer.

In particular, it is provided that the at least one coating is an oxide layer and/or nitride layer and/or sulfide layer applied to the winding elements 4, 5 by PVD or CVD methods. Preferably the coatings, a pre-defined number of the coatings, are disposed one above the other.

The bow noise can be further influenced by applying a coating. In this case, the coating influences the surface properties of the respective winding element. As a result of the small thickness of such a coating in relation to the cross-section of a winding element, the coating usually has a subordinate influence on the heat transport through the winding element. It has been shown that the surface condition which is directly influenced by the coating is additionally suitable to influence the bow noise beyond the material.

The first and second winding elements 4, 5 are preferably configured either as wires or as bands 10, 11, and all the winding elements of the composite winding layer 3 are configured as wires or as bands 10, 11. As is explained herein set out, a specific string of a musical instrument 1 can have a plurality of composite winding layers 3.

According to the particularly preferred embodiments, the outer winding layer 6 has winding elements 4, 5 that are bands 10, 11 or a wire that has been smoothed flat. Preferably the first winding element 4 is a first band 10 and the second winding element 5 is a second band 11, the first band 10 and the second band 11 having substantially identical thicknesses. The first and the second band 10, 11 preferably have a substantially rectangular cross-section, and a pre-definable edge formation. In particular, the formation of the edges is preferably a flat edge or a natural edge.

According to a particularly preferred embodiment, shown in FIG. 2, the first band 10 has a first width and that the second band 11 has a second width different from the first width. Density of a certain area can be adjusted particularly simply, as a result. This provides extensive possibilities for specifically influencing the tonal properties of a string of a musical instrument 1, in particular the string's bow noise. The bending resistance of the string and, therefore, its capacity to provide specific vibrations is directly influenced by the different widths. Preferably the first and/or the second band 10, 11 has a thickness in a range of 0.01 to 1.2 mm and a width in a range of 0.07 mm to 2 mm. If a third winding element is provided, it is further preferably provided that the third winding element is configured as a third band and that the third band has substantially identical thickness to the first and second band.

It can further be provided that the string of a musical instrument 1 has at least one further winding layer 7 between the string core 2 and the outer winding layer 6. This is preferably a composite winding layer 3. FIG. 2 shows such a further winding layer 7. In this further winding layer 7, the first winding element 4 and second winding element 5 are preferably a first wire 8 and a second wire 9. The first wire 8 and the second wire 9 have substantially identical diameter. Preferably the wire 8, 9 is a round wire although other cross-sections, an hexagonal cross-section in particular, can also be provided. Preferably the first and second wires 8, 9 are configured as round wire, and the diameter is between 0.05 mm and 0.4 mm.

It is provided that the composite winding layer 3 comprises at least one first and one second winding element 4, 5. In this case, three or more winding elements 4, 5 can be provided in one composite winding layer 3. According to particularly preferred embodiments, it is provided that the composite winding layer 3 comprises:
two first winding elements 4 and one second winding element 5 or
one first winding element 4 and two second winding elements 5 or
three first winding elements 4 and one second winding element 5 or
one first winding element 4 and three second winding elements 5 or
two first winding elements 4 and two second winding elements 5 or one first 4, one second 5, and one third winding element.

As noted above, first and second winding elements 4, 5 can be wires or bands.

Strings of musical instruments 1 frequently have a plurality of winding layers 3, 6, 7, arranged one above the other. Each winding layer 6, 7 can be a composite winding layer 3, in accordance with the invention. A composite winding layer 3 is preferably disposed adjacent to the string core 2.

FIG. 1 shows a particularly simply configured specific string of a musical instrument 1 which merely has one composite winding layer 3 which is at the same time disposed next to the string core 2 and also as outer winding layer 6.

FIG. 2 shows a further embodiment of a specific string of a musical instrument 1 which has a further winding layer 7 disposed nearest to the string core 2 and configured as composite winding layer 3. The outer or external winding layer 6 is also a composite winding layer 3. Furthermore, an intermediate winding layer can be provided that is a composite winding layer 3. A winding layer disposed between two other winding layers 3, 6, 7 is referred to herein as an intermediate winding layer.

Preferably, a polymeric damping layer is disposed on the composite winding layer 3 facing the string core 2. In particular oil-wax mixtures can be used as a polymer in this damping layer.

What is claimed as new and desired to be protected by Letters Patent is set forth in the appended claims and includes equivalents of the elements recited therein:

What is claimed is:

1. A string for bowed musical instruments having a supporting string core and at least one outer winding layer, said at least one outer winding layer comprising:
at least one first winding element, the first winding element being constructed of a first material having a first thermal conductivity; and
at least one second winding element, the second winding element being constructed of a second material having a second thermal conductivity, said at least one first winding element and said at least one second winding element being wound around the string core in the form of a multi-strand helix, the first winding element being configured as a first band and the second winding element being configured as a second band, said first band and second band having substantially identical thicknesses, and the first band and the second band each have a substantially rectangular cross-section, the substantially rectangular cross-section having a pre-definable edge formation, the outer winding layer being configured as a composite winding layer wherein the first thermal conductivity differs from the second thermal conductivity by at least 170 W/mK.

2. The string of claim 1, further comprising a third winding element in the composite winding layer constructed of a third material having a third thermal conductivity, the third thermal conductivity differing from the first thermal conductivity and from the second thermal conductivity by at least 170 W/mK.

3. The string of claim 1 further comprising at least one further winding layer disposed between the outer winding layer and the string core.

4. The string of claim 3, wherein the at least one further winding layer is configured as a composite winding layer.

5. The string of claim 1 wherein the first band has a first width and the second band has a second width that is different from the first width.

6. The string of claim 2 wherein the third winding element is configured as a third band and that the thickness of the third band has a thickness substantially identical to the thickness of the first and second band.

7. The string of claim 1 wherein the composition of the composite winding layer comprises a combination that is selected from a group of combinations consisting of:
two first winding elements and one second winding element,
one first winding element and two second winding elements,
three first winding elements and one second winding element,
one first winding element and three second winding elements,
two first winding elements and two second winding elements, and
one first winding element and one second winding element and one third winding element.

8. The string of claim 1 wherein material of at least one of the windings is made of a material selected from a group consisting of: steel, silver, silver alloy, aluminium, aluminium alloy, titanium, titanium alloy, nickel, and nickel alloy.

9. A steel string of claim 8, wherein the steel has a Cr content of at least 5% and/or an Ni content of at least 5%.

10. A steel string of claim 8 wherein the steel has a Cr content of 17% to 20% and an Ni content of 8% to 12%.

11. A silver string of claim 8 wherein the silver string is pure silver.

12. A silver string of claim 8 wherein the silver string has a degree of purity selected from a group consisting of 99.999%, 99.6%, and fine-grained silver.

13. A silver alloy string of claim 8 wherein the silver alloy is selected from a group consisting of: AgCu, AgCu 2, AgCu 6, AgPt 16, AgRh 16, AgCuNi, and Sterling silver.

14. An aluminium alloy string of claim 8 wherein the aluminium alloy is an aluminium kneading alloy selected from a group consisting of AlMg, AlMg 5, AlMgMn, AlCuMg, AlCuSiMn, AlZnMg, and AlMgSiCu.

15. A titanium string of claim 8 wherein the titanium is a grade of pure titanium selected from a group of titanium grades consisting of Grade 1, Grade 2, Grade 3, and Grade 4.

16. The string of claim 8 wherein the titanium alloy is a titanium kneading alloy selected from a group consisting of TiAl 6 V 4, TiAl 6 V 6 Sn 2, and TiAl 4 Mo 4 Sn 2.

17. The string of claim 8 wherein the nickel alloy is a nickel kneading alloy selected from a group consisting of Ni99.2, Ni99.6, Ni99.8, and NiMn2.

18. The string of claim 1 wherein the string core has a configuration selected from a group consisting of a single wire, a wire cable, a plastic fibre bundle or as natural gut.

19. The string of claim 1 wherein a polymeric damping layer is disposed on at least one region of the composite winding layer facing the string core.

20. The string of claim 1 wherein at least one coating is disposed on at least one of the winding elements.

21. The string of claim 20 wherein the at least one coating is at least one of an oxide layer, a nitride layer, or a sulfide layer.
